(19) United States
(12) Patent Application Publication
(10) Pub. No.: US 2021/0019455 A1
(43) Pub. Date: Jan. 21, 2021

(54) METHOD AND SYSTEM FOR CALCULATING A SPACE PLANNING AND GENERATING DESIGN SOLUTIONS ASSISTED BY ARTIFICIAL INTELLIGENCE

(71) Applicant: SMARTSCAPES STUDIO, S.L., Malaga (ES)

(72) Inventors: Juan BORDALLO RUIZ, Malaga (ES); Alejandro PLAZA YANEZ, Malaga (ES)

(21) Appl. No.: 16/931,958

(22) Filed: Jul. 17, 2020

Related U.S. Application Data
(63) Continuation of application No. PCT/ES2019/070500, filed on Jul. 17, 2019.

(51) Int. Cl. G06F 30/13; G06F 30/12; G06T 19/20

(52) U.S. Cl. CPC G06F 30/13; G06F 2111/02; G06T 19/20; G06F 30/12

(57) ABSTRACT

Method and system for calculating space planning of a building, using a building database (31), with unit distribution possibility tables (33), and compatibility tables (33, 34) showing the compatibility between them, whether horizontal, vertical or both, and comprising: defining (38) design criteria of the units and need program parameters; defining (39) a set of parameters of the typology and shape of the building; searching (40) in the vertical distribution table (33) for those that are as close as possible to the parameters defined; establishing (41) relation possibilities between the floors obtaining compatible houses; filtering (42) the design solutions which meet the design criteria; selecting (43) the buildings with houses as close as possible to the parameters and to the need program; calculating (44) the parameters which define floors of a building and distribution units by means of regression algorithms, decision trees or neural networks.

### OBJECT OF THE INVENTION

The present invention is framed within the field of computer-aided design and more specifically, within the field of artificial intelligence-aided architectural design.

An object of the present invention relates to a method for calculating space planning and generating design solutions and, more specifically, a method based on the computer algorithm-aided generation of architectural design solutions.

Another object of the present invention relates to a system for generating design solutions that executes the method for generating design solutions of the invention.

### BACKGROUND OF THE INVENTION

The generation of architectural solutions involves producing a solution that satisfies multiple design criteria within different scopes such as for example urban criteria, market or product criteria, constructive or technical criteria, economic criteria, architectural or aesthetic criteria. These criteria, which can be objective or subjective in nature, are what define the final result.

Therefore, the initial phase of the architectural design of a building should result in space planning of the building. This is this phase where the total space of a building is distributed into the different units and rooms that form it and they are ordered defining a spatial hierarchy (topology) which primarily responds to the functional criteria and to another class of criteria to which the building must respond. Therefore, it is in this step of the process where the most important architectural design decisions concerning the building are made, conditioning the final result of the design process.

This space planning process therefore consists of transforming a spatial program (need program) into the geometry which, on one hand, is the closest to this need program and its requirements, and on the other hand better responds to the different design criteria, wherein this latter condition must be assessed by the designer in each version by weighting the suitability with respect to the different criteria of the solutions as a function of the objective sought, given that they are all dependent on the same resulting geometry (for example, one solution may be worse than another one with respect to the cost, it may be more expensive, but it may have a better energy performance, so it may be more selectable as a function of the project).

With the aim of adapting the design solutions to the imposed criteria, architects and designers currently work manually with conventional tools by means of a process based on trial and error and relying on their intuition and experience. Even when computer-aided design methods are used, the suitable application of the design criteria is usually carried out manually, the computer only facilitating the drawing process (CAD programs) and/or the digital construction process of a building (BIM environment).

In this way, the architectural project is at present planned as a progressive process carried out manually in which the designer, taking into account the design criteria of the project, draws a first design solution, based only on their own intuition and accumulated experience, in order for its result to then be evaluated manually with respect to the different criteria required for the project. The designer then remodifies the first solution generated, therefore producing different versions and adaptations to optimise the result. This process is repeated as many times as is necessary to achieve a satisfactory result. Therefore, the generation of a design solution meeting the criteria imposed is based on the skill and experience of the designer and on the success that they may have in each specific case.

This means that the current process for generating designs is slow, because the design has to be redrawn manually or by means of a CAD program continuously every time said design is optimised, which involves an increase in the cost of the project because considerable involvement of specialised manpower becomes necessary, which in turn produces non-optimal and improvable solutions as it is based on manual work and limited time. In addition, the time, cost and success of generating a suitable solution mainly depend on the experience of the designer and their intuition and subjective criteria, the results in each project being different.

On the other hand, taking into account that the architectural process is a fundamental part of the construction of a new building, the mentioned drawbacks are projected towards the rest of the value chain of the construction to the final users of the building, who may encounter long waiting times and delays to the projects, increases in prices and quality limited by the manual nature of the process.

### DESCRIPTION OF THE INVENTION

The present invention describes a method of artificial intelligence-aided space planning with the aim of achieving the architectural solution of a building that best fits the spatial need program and technical design criteria established by the user (specification of number and type of units in a building, areas and dimensions for each unit and the distribution thereof in each unit).

In this way, the method allows the optimal space planning of a building to be achieved, that is, the solution that best fits a given need program (number and types of units to be arranged and areas for each room) and meets the technical design criteria (minimum interior distances in each space) for a typology and other design features chosen by a user. The need program with respect to the units (houses) refers to the areas of each room for each type of house in the building and with respect to the building; they are the number of houses of each type existing in the building.

The invention is contemplated as a scientific solution to the technical problem of space planning to obtain the solution that deviates the least from a given need program for design features previously selected by the user or recommended by the system.

The invention relates to two complementary methods, a first method for generating a design solution based on a set of input parameters and a second method for training a design solution generating algorithm.

The method for generating a design solution of the invention allows for a novel way of carrying out an architectural design aided by artificial intelligence and implemented by means of a computer.

The invention is based on defining architectural design algorithms which can be trained by means of machine learning methods and applied to the design of buildings.

The invention also relates to a system for generating design solutions comprising a database, which stores a set of design solutions, an assistance module for receiving a set of design solutions from the database, a set of input parameters and user standards and generating a set of output parameters which completely define valid design solutions, a design base module for receiving the design parameters which completely define valid design solutions of the assistance module and generating a graphical representation and the measurement parameters of said design solutions, and a viewing module for allowing interaction with the user, such that it receives data from the user and shows data of the assistance module and of the design base module to the user.

The invention also relates to a system for training a design solution generating algorithm comprising a design parameter generating module for generating a set of combinations of design parameters which completely define different design solutions, a design base module which receives the combinations of design parameters from the design parameter generating module and generates a graphical representation from which it extracts a set of measurement parameters and a database which receives the parameters which completely define the different design solutions, the graphical representations thereof and the measurement parameters of the design base module and stores them.

As has been explained, both methods use a subprocess for representing a design solution based on defining a set of design parameters fully defining the design solution, also called the parametric definition of an architectural typology, such as for example double orientation multi-family housing, this subprocess for representing a design solution is carried out by means of the design base module.

Alternatively, the design base module also allows architectural typologies to be digitalised and parametrised such that the design of each solution does not need to be encoded. To that end, the design base module is provided with a drawing with the distribution of a typology, which is automatically parameterised following the steps of:
providing the drawing to be parametrised with the distribution of the typology (floorplan);
identifying the division lines which demarcate the rooms;
grouping the divisions by classifying them based on their orientation and type;
extracting a grid with axes coinciding with the coordinates or parameters of the groups of lines (e.g., values of x coordinates for the vertical lines and y coordinates for the horizontal lines); and
converting these parameters into system variables.

A floor provided in a parametric system defined by a set of variables is thereby converted.

For generating new floors from this parametric system, the following steps are carried out:
introducing a value for the system variables; and
generating a new distribution, maintaining the initial topology.

The design base module allows multiple design solutions to be generated from a single drawing, maintaining the same original topology or spatial hierarchy of the architectural type introduced, but in which the (interaxis) dimensions are variables, in this way allowing a broad set of design solutions with the same spatial hierarchy and different surface program (different area values of each space) for each design to be generated in a simple manner.

This module is applicable to any spatial typology defined in 2D (layout), and at different scales, which allows it to be used, for example, both on a house scale, in which the divisions demarcate the rooms, or on a building scale, where the divisions demarcate the houses.

Alternatively, in this subprocess it is possible to introduce in the design base module the design parameters which completely define a design solution, which may be viable or inviable, both exterior and interior, such as the width and length of the rooms, number of rooms, position of the rooms and core type, among others; then, a graphical representation of the design solution defined and a set of measurement parameters are produced by means of a design algorithm previously provided, already existing or created for the project.

The design base module therefore has the function, in this case, of representing a design solution depending on the design parameters which completely define the design, generating viable and inviable design solutions, and extracting measurement parameters from the design represented. To that end it has a geometry submodule which generates the graphical representation of the design, and a metric submodule which generates the set of measurement parameters.

The method for generating solutions of the invention allows viable and optimised design solutions to be generated adaptively based on a set of known parameters and standards by means of an assistance module for generating valid solutions.

Firstly, a design solution database is provided which contains a set of ordered design solutions and a set of design solutions is extracted from said database. Preferably, this database is generated by means of the method for training a design solution generating algorithm by an administrator of the system.

Then, a set of standards, or design criteria, is defined, which the sought design solution must meet, based on a selection made by the administrator of the system, for which purpose values are introduced by the user, such that the database is filtered according to the values given to the set of standards, whether they are client, product or market standards, such as minimum and maximum surfaces per room, minimum and maximum dimensions per room and proximity situations of each room, thus obtaining a filtered set of design solutions which meets the set of standards introduced.

Then, from all the parameters defining the typology, a set of input parameters, also called design options, is established based on a selection carried out by the administrator of the system who establishes said design options, the value of which is defined by the user, aided by the system during the design process. This step can be carried out once or during the generation of each design solution.

With the aim of facilitating the input of data and avoiding the introduction of input parameters leading to inviable design solutions, a validity interval of each one of the values of the set of input parameters is obtained such that the user can select the specific value of each parameter within the provided validity interval. For each input parameter, the set of all the values that said parameter can take is established, for example the interval in which all the values are framed which said parameter takes in all the solutions contained in the database which have been previously supplied to the application, thus ensuring the viability of the solution.

In addition, each time the user introduces an input parameter, the validity interval of the input parameters remaining to be introduced is recalculated. The determination of the validity intervals can be carried out by any method of database classification, indexation or management, as well as machine learning, which offers dependency patterns of each variable.

Preferably, the calculation of the validity intervals is carried out by means of prior indexation of the data from the database in a data tree. To that end, the values of each of the continuous design parameters in the database are discretised, for example, if the width of a house is 15.65 m and this field is discretised every 1 m, its discrete value will be 16 m, a discrete value being obtained for all the design parameters, both those which have been discretised and those which already had a discrete value. Then, each design solution is classified by an index which corresponds to the discretised values of the design parameters which will be used to carry out a query of the data in a subsequent step.

The result is a data tree in which each index groups combinations of design parameter values which give rise to viable design solutions which form a branch of the data tree which contains all the design solutions adhering to the values of the index. Thus, in the method for generating design solutions, the data tree allows the validity intervals of each one of the input parameters to be known.

This process of generating a data tree is carried out for each architectural typology existing in the project.

In the case of a project with various typologies (e.g. a residential building with two- or three-bedroom flats), the index corresponds to the common parameters of the houses. With the aim of combining the different architectural typologies in the same project, the set of indices of each typology are intersected, obtaining, as a result of the intersection, the indices coexisting in all the typologies at the same time, that is to say, the compatibility map of the typologies.

In the method for generating design solutions, the compatibility map allows the validity intervals of each one of the input parameters to be known such that when a value of an input parameter is introduced, filtering is carried out, leaving the design solutions whose indices comprise the value of the parameter introduced producing the validity intervals of each one of the input parameters remaining to be introduced, i.e., the values of said input parameters which produce solutions meet the standards.

Thus, once the value of a first input parameter within a first interval of possibilities is introduced by the user, the database is filtered based on the indices applied and the value introduced, and a second more reduced interval of possibilities is obtained for the rest of the input parameters of the set of input parameters, these steps being repeated with all the input parameters until the last input parameter is reached.

Alternatively, the calculation of the new validity interval can be made discarding the values that belonged to the design solutions which are discarded based on the selection of the input parameter introduced and ensuring that the combination of the parameters introduced by the user corresponds to a valid design solution, producing a second filtering of the design solutions already filtered based on the set of standards, leaving only those that meet, in addition to the standards, the parameters introduced by the user without proceeding to index the database.

The values defined by the user for the set of input parameters, within the intervals of possibilities provided, involve defining the design by the user and its viability, that is to say, compliance with the standards defined initially by the user, is ensured by calculating the validity intervals.

Furthermore, after establishing the set of input parameters and before establishing the validity intervals, the set of input parameters can be hierarchised, that is, a hierarchy of dependency is established from the most relevant input parameters to those having the lowest implication with the aim of determining the order of introducing the parameters defining the design. The definition of the required input parameters, the design options and the hierarchy of said parameters is carried out based on a selection carried out by the administrator of the system based on the compatibility map generated during the indexing of the database if this has been carried out. This hierarchisation allows the input parameters of the design process to be ordered from greater to lesser relevance, such that the introduction of less relevant parameters prior to others of greater relevance is avoided, thus preventing the possibility of the selection of the input parameters with greater relevance being conditioned by the selection of the input parameters of less importance, thus reducing the calculation time of the validity intervals. This step does not need to be carried out in each generation of a design solution, but can be carried out once by the administrator.

Lastly, once all the input parameters have been selected, a design solution meeting the selection of the input parameters introduced is generated by the application and obtained in real time.

The generation of the design solution consists of determining a set of output parameters generated from the standards, the set of input parameters and the design solution database filtered by the standards introduced, by means of machine learning algorithms. In particular, the set of output parameters can be obtained by means of a multivariable linear regression algorithm.

Alternatively, the method of the invention can make use of a reference building database, preferably generated by means of the training method described in the present application from a house data table, a building floor data table and a vertical floor compatibility data table.

Thus, with the aim of defining the three-dimensional structure of the building from a two-dimensional system such as the design base module, the reference building database is structured the same way as the spatial structure of the buildings, resolving by means of related tables the different groups of units of a smaller scale which form the building, whether they are horizontal groups, vertical groups, or both. In this way, for the case of a reference building database of single-family houses, it will consist on one hand of a house floor type table, and on the other hand of a vertical floor compatibility table, which will indicate which floors of a house are compatible with one another (position of the stairs and coinciding vertical elements). In the case of the typology of semi-detached houses, for example, together with this vertical compatibility table, a horizontal compatibility table will define the different associations of rows of housing of the typology.

For the case of a building with multi-family houses (an apartment building), the table of houses which contains the possibilities of the interior distribution of the houses are grouped horizontally by means of the building floor table, which defines the possibilities of associating the houses to one another to build a floor of a building, and these are in turn related vertically by means of a vertical compatibility table that defines which floors of a building are compatible with one another.

The different combinations of the tables with one another will produce the database of possible solutions for a building.

To prevent an exponential and infinite combinatorics of solutions, the database can be carried out in several phases. For example, for the case of the multi-family building, prior to the interaction of the user, the building floor and house tables can be defined and once the user has introduced the definition of the floors of a building to be used, the third vertical compatibility table can be performed on just the floors that meet the specifications introduced by the user, which largely limits the number of combinations possible.

In this variant of the method, the user introduces a set of design features and parameters that the spatial structure of a building must meet, such as the type of circulation (horizontal passageways or vertical stair cores, for example), the house program (number of houses for each typology according to the number of bedrooms and rooms) or the dimensions of the building (length, width, number of floors), for example. This set of design parameters define the typology of building or the set of viable typologies. Thus, the floors of a building that are closest to the typology sought for each type of floor of the building defined and meet the standards introduced by the user such as the target minimum surfaces (area of each house) and dimensions (width and/or length of the house) are extracted from a building floor database. Then, a relational search between the floors of a building selected from the database is established to explore their vertical compatibility. Such that from each floor of a building selected, the viable vertical groups of house floors forming the buildings (those groups with a vertical structure, stairs, installations or/and structure that coincide) are obtained, each comprising a set of compatible houses. From the set of reference buildings obtained, those with a house program and design criteria that are closest to the set of parameters set by the user are selected. For the case of these reference buildings corresponding to different typologies of building or house, these solutions will belong to different datasets, so the system will select, by default, the dataset with the best results by means of setting the parameters which select it, which is the basis of the system for recommending non-numerical features.

Lastly, as in the previous case, both the divisions between houses in different floors and the divisions between rooms in different houses are suited to the objectives and dimensions (area of each typology of house and of each of its rooms and minimum lengths of each room for each house) established by the user by means of a nested multivariable linear regression algorithm for each different phase (to set the parameters of the floors of a building to achieve the distribution of houses and the distribution of the interior of houses to achieve the interior distribution thereof) or by means of any other statistical algorithm or algorithm from the field of applicable machine learning, such as decision/regression trees and neural networks.

The use of these machine learning algorithms allows the aided design system to be efficiently constructed, because they allow for the possibility database to be generated from discretised parameters, and they can, however, offer results for any input that is introduced within the range of viability in a continuous manner, the dependency of parameters on one another for values not existing in the database being automatically resolved.

Otherwise, trying to cover all the possibilities with only a database is completely inviable due to the infinite amount of possibilities that are exponentially generated.

In the present application, mention of the house, floor of a building or building that is closest to a set of parameters that has been previously set refers to that which deviates the least from said parameters with respect to the set value.

The method described can be carried out jointly for all the architectural typologies selected in the project, the parameters of each typology being analysed separately and the dependent parameters of the suitability among the different typologies, that is to say, based on a set of continuity rules by means of a calculation of the intersection between the validity intervals of each one of the input parameters of the different selected typologies described above, this means, for example, that it can be defined that the width of a building should be constant in all the houses of a straight façade linear block. Then, for each typology, after jointly defining the input parameters based on continuity rules, the parameters themselves of each typology unrelated to the rest are defined independently.

The set of standards and input and output parameters of the design can be introduced in the design base module to produce a graphical representation of the solution from which a set of measurement parameters of the viable design solution generated that meets the standards and the set of input parameters introduced and output parameters generated are obtained.

Preferably, the set of output parameters obtained by the method described is under the control of the user, such that the user has the capacity to approve these parameters or modify them to seek another solution distinct from the one recommended.

Likewise, the method of the invention may comprise a step of manual editing. In this step, the user can modify the design generated by means of drawing editing tools which allows for solutions not contemplated by the automated design system to be covered.

The combination of the manual editing and of the design base module allows new functionalities to be fed back into the system continuously in order to increase the design potential of the technology. In this way, the designs that are made manually by users feed the design base module that produces the database, in order to enrich it and offer new typologies and designs.

Likewise, the selection of the input parameters can be made in an assisted manner, such that a suggestion is provided for the values which optimise the design solution with respect to a measurement parameter of said design solution or a specific ratio between parameters, for example, in the case of a residential project, the best fit with respect to the target surfaces and dimensions defined by the user (deviate the least), the floor space, that is, the usable area of the house minus corridors, bathrooms and pantries, the usable area to built area ratio, including the proportional part of common areas or the cost per square metre, among others. Said measurement parameters and/or ratios are previously included in the database associated with each design solution stored. With the aim of providing a suggestion of an optimal value of a specific parameter or ratio, once the database is filtered with respect to the standards, during the selection of the input parameters, all the design solutions available are ordered in the indices resulting from said selection with respect to said parameter or ratio. This step is repeated for each typology existing in the project.

For example, in the event that the measurement parameter chosen for optimisation is the total floor space of a building, all the floor space values of each house are multiplied by the number of houses of each typology, the total floor space per typology thus being obtained; then, the sum of these floor spaces gives as a result the total floor space for each option. Lastly, the design solutions with respect to the total floor space produced are ordered and the design solution producing the most floor space is selected, the combination of input parameters producing the most optimal design solution with respect to the total floor space from among all the viable design solutions thus being identified.

Similarly, the user can change the recommended values of the input parameters, introducing others; consequently, the process is repeated to calculate the remaining values producing the most optimal combination.

The introduction of the input parameters by the user can be carried out by means of the viewing module which allows a value to be established for each parameter in different ways, such as for example analytically, introducing the numeric data directly by means of a selector or interacting with the graphic representation of the design solution, whether it is 3D or 2D, such that the user can select the change to be carried out in said graphic representation.

The method for generating design solutions can allow the user to know in real time all the data of the project, the standards, the set of input parameters and the set of output parameters, such as for example existing architectural typologies, surface areas of each typology, surface areas of the different rooms and general urban data of the project and specific data for each typology, among others.

This method can also comprise a direct exporting step of the design to BIM environments which consists of applying a family or previously parametrised object to each one of the constructive components, such as a window or a door, among others, keeping the result in BIM format.

This feature allows the development of subsequent phases of the project to be carried out continually and seamlessly, since it digitalises the complete design process, not only the drawing or the construction of the building. This means that in subsequent phases the generated geometries can be recognised as architectural entities which allows the handling and processing of the same.

Similarly, the definition of the constructive entities in a BIM environment allows the implementation of an optimisation module comprising a search generating algorithm in conjunction with an environmental simulator which provides environmental metrics. The search algorithm of the optimisation module enables environmental criteria to be applied to the final solution, finding the optimal design solution based on a calculation of the energy consumption.

In order to carry out the calculation of the energy consumption, the system can comprise a simulation and calculation algorithm that receives a set of environmental data and data on the surroundings from the administrator of the system and stores them in a database. Then, once a viable design solution has been achieved, the energy consumption is calculated for that design solution by performing a simulation of the environmental conditions with the aim of generating environmental metrics and showing them to the user to decide.

Alternatively, the optimisation of the design of the enclosure can be automated, for which purpose a genetic algorithm is applied, which modifies the position and composition of some constructive elements without altering the definition of the design solution generated, such that energy consumption is minimised, that is, the position of constructive elements that do not alter the design solution and of the materials, thicknesses and layers, among others, of the materials forming said constructive elements, are modified. The modification of the constructive elements can comprise, for example, a change in the arrangement of terraces, the windows or materials of the exterior enclosures.

In addition, with the aim of optimising the modification of the constructive elements, a genetic algorithm is used which enables the different positions and compositions of the constructive elements to be iterated with the aim of finding the one that has the lowest energy consumption.

This same process described for the automated environmental optimisation of the solution is applicable for the optimisation based on other criteria, such as economic criteria, cost-benefit criteria, or criteria of another class, as well as multi-objective optimisations where the system optimises the solution with respect to several parameters at the same time.

On the other hand, the method for generating design solutions can also automate the calculation of the budget of the construction of the design in real time. To this end, previously stored data on prices of each item is used and is applied to the measurement resulting from each entity generated, for example, the previously stored price of the structure square metre is applied to the structure surface area. This feature allows the economic repercussion which each decision has on the input parameters and the standards within the design process to be known.

The method for generating design solutions of the invention can also comprise a previous step of automatically determining the optimal arrangement of the buildings which form the project on an empty lot, in relation to measurable optimisation criteria, based on the definition of said empty lot and a set of data of the surroundings previously provided by the administrator of the system. The definition of the optimal architectural arrangement uses a set of values obtained for the measurable optimisation criteria for a specific arrangement, calculated by means of carrying out a simulation of said arrangement, such as the environmental criteria like energy consumption, economic criteria like cost or benefits, or functional criteria like accessibility, thus obtaining the optimal architectural arrangement for the lot and the data on its surroundings previously introduced. In particular, the definition of the optimal architectural arrangement can be obtained iterating the different architectural typologies of the buildings which form the arrangement until finding the optimal one based on one of the previously defined optimisation criteria, such as the consumption or minimum cost criteria.

The method for generating design solutions of the invention allows for an increase in the precision and efficiency of the traditional process, drastically reducing the design time and development of the architectural project to produce optimal design solutions in real time.

Thus, the method allows the designer to free themselves from the mechanical development tasks in order to concentrate on making decisions concerning the design and thus improving its added value.

In addition, it allows greater digitalisation of a sector based on the intensive use of high-cost specialised labour by means of introducing novel artificial intelligence technologies which allows a more efficient and informed design process reducing the dependency on intuition.

Consequently, the described method improves the decisions, since it allows a multitude of variants concerning a project to be carried out in a very short time with the guarantee of providing optimised solutions without human error, improving productivity whilst reducing the design time and improving profitability whilst optimising the projects and reducing expenses to increase the benefit.

Similarly, these advantages extend to the other agents involved in the construction supply chain such as architects, project managers, urban planners and public institutions, as well as the final user who can receive an improved product better adapted to their requirements and their needs, and more quickly and economically as the production costs are reduced.

On the other hand, the method for training a design solution generating algorithm is based on the exploration of viable design solutions which can be generated within a scope of design parameters, provided by the administrator of the system by means of a design parameter generating module.

This method, therefore, allows a set of design parameters completely defining the design to be iteratively generated, and, by making use of the design base module, it allows the graphical representation and the measurement parameters of a design solution to be generated for each set of design parameters generated. The design base module can be configured for receiving all the parameters which completely define the design solution and generating a drawing of said design solution or, alternatively, it may have digitalised and parametrised an architectural typology such that upon introducing a set of system variables (smaller in number than the set of parameters which completely define the design solution), new distributions are generated, maintaining the spatial hierarchy (topology) of the architectural typology.

The proposed training method therefore comprises the steps of establishing a first set of design parameters previously defined by the administrator of the system and obtaining multiple combinations of said design parameters by means of applying a design parameter generating routine consistent with an algorithm which scans all the combinations of parameters homogenously or selectively, taking into account the combinations already generated.

Then, a graphical representation of each solution defined by each combination of design parameters is generated from which a set of measurement parameters are extracted by means of the design base module, thus representing a design solution for each of the combinations of design parameters obtained. Lastly, the design solutions obtained for all the combinations of design parameters are stored in the database.

Alternatively, the training method can be applied for generating complete building databases. Thus, a set of building floor parameters which completely define the spatial division of each floor (layout) are introduced in the design base module. From this data, the design base module generates a design solution, that is, a spatial distribution, of floors of buildings.

Then, the same method is applied in the case of houses of buildings, that is, a set of building house parameters which completely define the division of the space of each house (layout) are introduced in the design base module. From this data, the design base module generates a design solution, that is, a distribution of the floor space of the houses.

Next, the results generated are analysed with the aim of making the houses generated compatible with the floors generated, such that a table of houses compatible with each floor and a floor compatibility table are generated. In that way, a complete building database comprising different typologies of floors and each floor with different house typologies is generated.

As previously indicated, the structure of the database to be generated will correspond with the data structure of the typology of building and more specifically how the different units are grouped together, intermediate compatibility tables being defined to resolve these groups, which may be horizontal, vertical, or both.

This method allows complete building databases to be generated rapidly and efficiently, instead of later generating a building by means of the compatibility map of houses in each case, which entails the need to program the combination of the complete solution.

Preferably, the graphic representation of the design solution can be stored in the database instead of storing only the parameters defining it. Thus, time is saved in the method for generating design solutions as it is not necessary to generate the graphic representation of the design solution, but rather it is loaded directly from the database.

With the aim of optimising the storage of the design solutions in the database, said previously generated design solutions can be ordered based on their features, such as architectural typology, the standards they meet, the parameters of the interior and exterior, among others.

In addition, the storage space in the database can be optimised if a design solution filter is included which discards the solutions generated which do not meet minimum acceptance criteria, which cannot correspond to surface areas, dimensions or proximity rules. In this way, a minimum quality is ensured in the solutions which are ultimately stored in the design solution database.

The method for generating design parameters allows combinations of design parameters to be generated which include, for example continuous parameters such as the total width of a house, its length, dimensions of each room or discrete design parameters such as the staircase core type, the position thereof in the building, the position of the kitchen, front or rear, of the master bedroom, amongst others. In addition, the module for generating design parameters can be of a standard type which allows all the possible or genetic type parameter combinations to be searched, which allows a genetic algorithm to be sought in an optimised manner, with the aim of scanning the entire spectrum of possible combinations among the parameters, whether homogenously in the case of a standard type or more selectively in the case of a genetic type. In the case of the design parameter generating module being of a genetic type, the search is carried out as a function of the combinations of parameters already generated, which allows the combinations of parameters meeting the minimum criteria to be searched for more efficiently, as the search algorithm is implemented with a genetic type algorithm which discards the combinations not meeting said minimum criteria and is concentrated on those that do meet them.

The system is therefore progressive and increases its functionality as the generated database grows. This aspect allows its applicability to be increased with respect to the different functionalities and variants which a typology can have and increase its reach in different markets.

### DESCRIPTION OF THE DRAWINGS

In order to complement the description being made and with the object of helping to better understand the features of the invention, in accordance with a preferred practical exemplary embodiment thereof, said description is accompanied, as an integral part thereof, by a set of drawings where, in an illustrative and non-limiting manner, the following has been represented:

FIG. 1 shows a schematic drawing of a preferred embodiment of the system for generating design solutions of the invention.

FIG. 2 shows a schematic drawing of a preferred embodiment of the design base module.

FIG. 3 shows a diagram of an embodiment of the method for generating design solutions of the invention.

FIG. 4 shows a schematic drawing of a preferred embodiment of the system for training a design solution generating algorithm of the invention.

FIG. 5 shows a diagram of an embodiment of the method for generating design solutions of the invention.

FIG. 6 shows a diagram of an embodiment of the system for generating design solutions making use of a building database.

FIG. 7 shows a diagram of an embodiment of the method for generating design solutions making use of a building database.

FIG. 8 shows a diagram of an embodiment of the step of generating multiple design solutions from a drawing by means of the design base module.

### PREFERRED EMBODIMENT OF THE INVENTION

The invention relates to a method for generating design solutions and the associated system for generating design solutions.

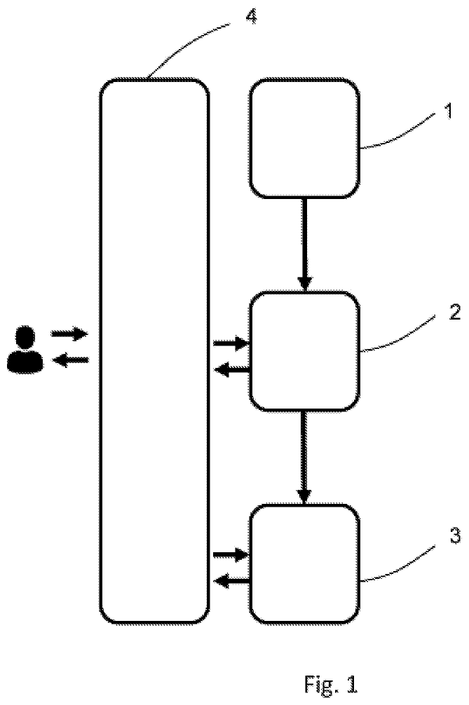

FIG. 1 shows a preferred embodiment of the system for generating design solutions which executes the method of the invention. The system comprises a database (1), an assistance module (2) for generating valid solutions, a design base module (3) and a viewing module (4).

The database (1) comprises a set of design solutions stored such that it supplies the assistance module (2). Said assistance module (2) interacts with the user by means of the viewing module (4) such that it receives a set of input parameters which the user introduces and produces a set of output parameters, such that the set of input and output parameters fully define the design.

The assistance module (2) is connected to the design base module (3) and transmits to it the input parameters introduced by the user and the output parameters, generated by the assistance module (2) itself, forming a set of design parameters fully defining the design solution. The design base module (3) receives the design parameters and generates a graphical representation of the design solution from which a set of measurement parameters are extracted.

The design base module (3) can also interact with the user, showing, by means of the viewing module (4), the graphical representation as well as the measurement parameters generated, and allowing the user to modify them.

During the entire operation of the assistance module (2) and of the design base module (3), the user has complete control by means of the viewing module (4), therefore allowing the modification of the parameters defining the design at any time.

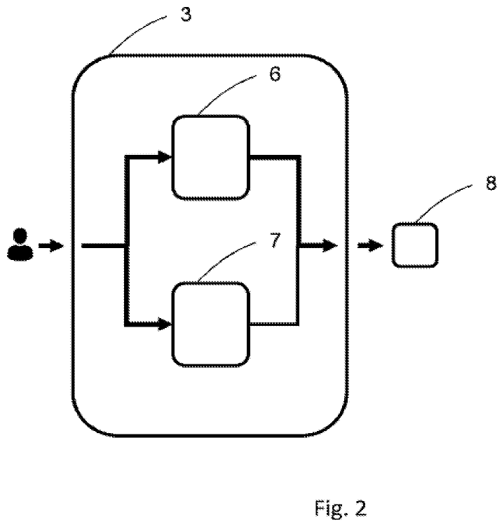

FIG. 2 shows a schematic drawing of a preferred method of operating the design base module (3). The design base module (3) receives a set of design parameters, including specifications of the design, data on the definition of the building and data on the definition of the house, which are passed to a calculation module comprising a geometry submodule (6) which generates a graphical representation of a design solution, and a metric submodule (7) which generates a set of measurement parameters. This module (3) is therefore responsible for representing the design solution (8) whilst supplying it with all the design parameters defining the design solution.

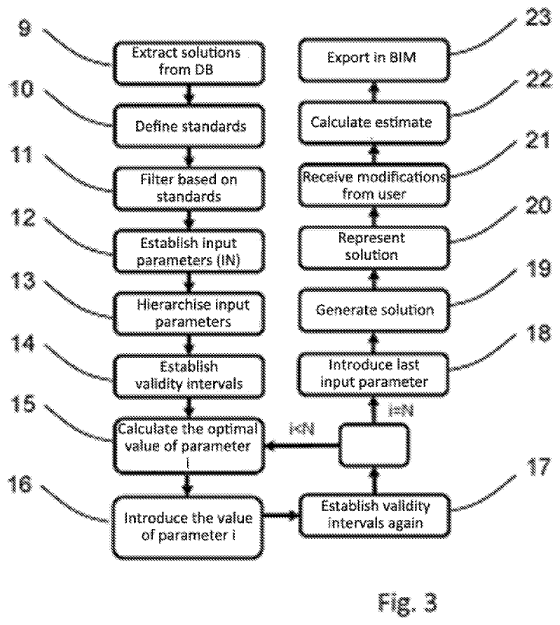

FIG. 3 shows a preferred embodiment of the method for generating design solutions of the invention which is carried out by means of an application forming part of the assistance module (2).

The application that executes the method therefore firstly extracts (9) a set of available valid design solutions stored in the design solution database (1).

Then, the application defines the architectural typology intended to be used based on a series of standards of the client, product or market, previously established by the administrator of the system and whose value is defined by the user. The defining (10) of the standards by the user allows the application to carry out a first filtering (11) of the solutions provided by the database (1), therefore leaving only the solutions meeting said standards. Preferably, the user can select various sets of standards such that the method is capable of simultaneously generating valid design solutions for various architectural typologies which, in this case, belong to the same project and therefore share common features.

Then, the application establishes (12) the input parameters that the user has to introduce based on a selection by an administrator of the system as is shown in FIG. 3, N input parameters are established. In each project, the number and type of input parameters that the administrator of the system establishes can be different. For example, the input parameters can comprise the parameters of the exterior and the interior of the house, both geometric and metric, the definition of the building, that is to say the features shared by all the houses with the aim of being linked to one building typology and the architectural typology of the house.

With the aim of optimising the functionality of the application and therefore of the method of the invention, the input parameters are hierarchised (13), that is to say, they are ordered based on their important in the final design, the administrator of the system being the one who defines the hierarchical order of the input parameters, that is to say, the design options such that the first input parameters that the application requires of the user are the most important ones in defining the design, for example, in the case of a multi-family house, the total width of the house has more effect on the final design of the house than the type of stairs of the building.

Based on this hierarchisation, the application establishes (14) the validity intervals of the input parameters, such that for each one the set of all the values is established which said parameter takes in all the solutions contained in the database (1) which have been previously supplied to the application, once they have been filtered by the standards imposed by the user.

In addition, for the N input parameters, each time a validity interval is established, the application calculates (15) and provides the value of the parameter within the interval which allows an optimal design solution to be generated, being a design solution maximising or minimising one or more previously defined optimisation criteria, whether they are parameters or ratios. Thus, the step of introducing (16) the value of an input parameter consists of maintaining or modifying the suggested value. Then, the combinations of viable parameters meeting the introduced parameter are filtered and the validity interval of all the other dependent input parameters is recalculated (17) according to the hierarchy, said validity interval being reduced as the values, which belonged to discarded solutions, are discarded, ensuring that the combination of the parameters that the user introduces corresponds to a valid design solution.

Thus, when a parameter i is introduced, where i is a natural number from 1 to N, whether it is the value provided by the application that allows an optimal design solution to be generated or the value modified manually by the user, the viable combinations are filtered by the parameter i introduced and the validity intervals of the rest of the parameters are re-established (17). The process is repeated until i is equal to N, that is to say, until the last parameter is reached. Then, the last input parameter (18) is introduced within the validity interval of the last parameter or the recommend one is maintained. Lastly, a machine learning algorithm is applied to generate (19) design solutions which, based on the standards, the input parameters and the database filtered by the standards, calculates a set of output parameters completing the definition of the valid design solution generated.

Said generating of design solutions is fully produced after the introduction of any parameter defining the design, since the rest of the parameters have a default value, thus the user can know the result of each modification carried out during the process and proceed to introduce the rest of the parameters in an informed manner, owing to the data which is presented, and guided, owing to the suggestions provided by the system.

Then, a graphic representation (20) of the generated design solutions is generated by means of the design base module (3). Preferably, the design solutions already represented can be stored in the design solution database (1). In this way, it is not necessary regenerate the representation of the valid design solutions, since their representation would already be generated.

The result is then shown to the user by means of the viewing module (4) who should decide if the design meets their expectations. In this respect, the method of the invention allows the user to modify (21) the generated solution, changing the parameters defining it, even if this involves the generation of an inviable solution.

The application can then calculate an estimation of the construction budget (22) of the generated design. To this end, data previously stored in a price database (1) is extracted which can coincide with the design solution database (1) which contains the price of materials per unit of measurement. The application then applies these prices to the measurements of the design solution generated, estimating the price of said construction.

Lastly, the solution (23) is exported in a BIM environment with the aim of supplying the subsequent digital construction process.

The invention also relates to a method for training a design solution generating algorithm and a training system associated with said method.

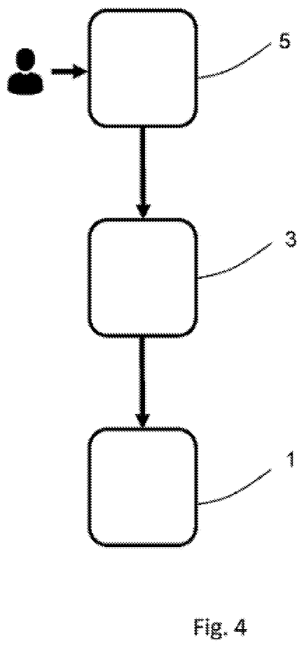

FIG. 4 shows a preferred embodiment of the training system which comprises a design parameter generating module (5), a base design model (3), similar to the one used in the system for generating design solutions and a database (1).

The design parameter generating module (5) of the system receives from the administrator of the system a scope of variation of the design parameters and generates multiple combinations of said design parameters, such that the spectrum of possible combinations is scanned, in this case homogeneously when it concerns a standard module.

The design parameter generating module (5) transmits the combinations of viable design parameters generated to the design base module (3).

Like in the system for generating design solutions, the design base module (3) receives the design parameters and generates a graphical representation of the design solution from which it extracts a set of measurement parameters.

The set of design parameters which allows for the graphic representation of the design solution is then stored in the database (1) which can be used as the design solution database (1) of the system for generating design solutions. The complete set of data allowing the graphical representation of the design together with the measurement parameters or the graphical representation of the design, with the parameters defining it and their measurement parameters can be stored in said database (1).

With the aim of optimising the storage of the design solutions in the database (1), said previously generated design solutions can be ordered based on their features, such as architectural typology, the standards they meet, the parameters of the interior and exterior, among others.

In addition, the storage space in the database (1) can be optimised if a design solution filter is included which filters the solutions generated which do not meet minimum acceptance criteria. In this way, a minimum quality is ensured in the solutions which are ultimately stored in the design solution database (1). To that end, once the measurement parameters of the design solutions of each combination of design parameters have been obtained, the solutions which the design solution filter considers not valid are discarded.

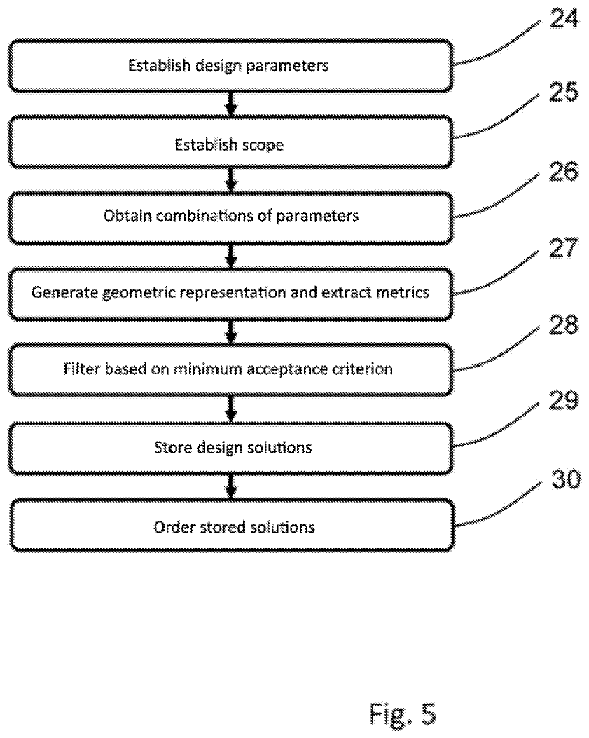

FIG. 5 shows a graphic representation of the succession of steps produced in a preferred embodiment of the training method of the invention, in this case by means of an application.

Firstly, the application, by means of the design parameter generating module (5), establishes (24) the design parameters of the typology, then, it establishes (25), based on a selection by the administrator, a maximum scope of values that a first set of design parameters can take. The parameters composing the first set of design parameters can be previously defined (24) by an administrator of the system as shown in FIG. 5.

Combinations of design parameters of the first set of design parameters are then generated (26) by means of the design parameter generating module (5), scanning the entire spectrum of possible combinations within the specified scope. The application is responsible in these steps for determining that the first set of parameters contains all the design parameters necessary for defining the design solution.

Then, by means of the design base module (3), a graphical representation is generated (27) for each generated combination of design parameters, from which a set of measurement parameters are extracted.

The design solutions generated based on minimum acceptance criteria previously provided by the user are then filtered (28).

A design solution for each combination of design parameters generated is then stored (29) by the parameter generating module (5) in the database (1) which will then be used as the design solution database (1) for the system for generating design solutions.

Lastly, the solutions generated and stored are ordered (30) based on their design parameters in the database (1) such that they are indexed.

Although the systems and methods described relate to the design of collective housing residential buildings, this method is applicable to any architectural typology, such as single-family houses, other residential typologies (hotels, residences, etc.), educational infrastructures (schools, institutes, universities, etc.), healthcare facilities (hospitals, clinics, etc.), cultural, religious facilities, etc.

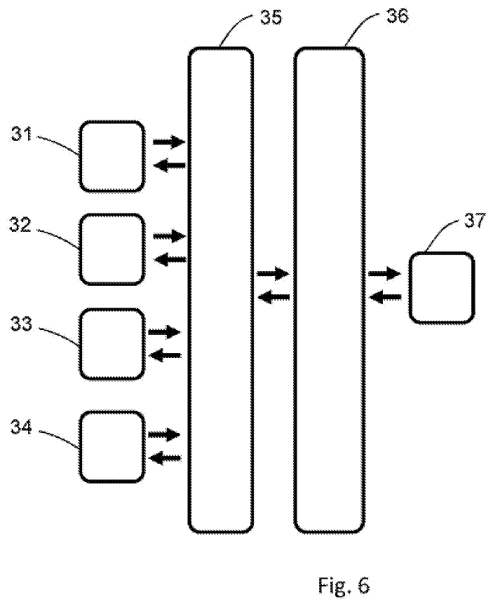

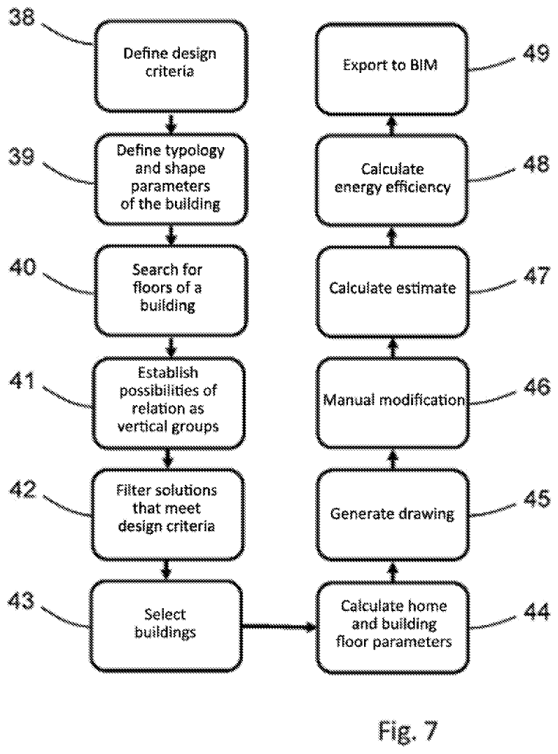

FIG. 6 shows a particular embodiment of the system for generating design solutions configured for carrying out the method implemented by a computer for calculating the optimal space planning and generating the corresponding architectural design of a building comprising:
a building database (31) which stores a set of typologies of buildings;
a house table (32) which stores a set of typologies of houses;
a building floor table (33) which stores the horizontal compatibility possibilities of the houses;
a compatible floor table (34) which stores the different vertical compatibility possibilities between the different floors of a building;
an assistance module (35) configured for receiving a set of parameters of the building, searching for the floors of a building which are as close as possible to the floor dimensions and characteristics defined, that is, the one that deviates the least from the parameters introduced, establishing the possible associations between the selected floors of a building with respect to one another, obtaining vertical groups of floors of buildings each comprising a set of compatible houses, selecting the buildings with houses that are as close as possible to the parameters set by the user that meet the design criteria introduced, and calculating the dimensions and parameters of the floors of the building and of the houses with the aim of finding the architectural solution which best fits the parameters (areas for each room and dimensions) set by the user by means of the sequenced application of multivariable linear regression algorithms;
a design base module (36), intended for receiving the parameters which completely define the valid design solution of the assistance module (35) and generating a graphical representation of said design solution and extracting a set of measurement parameters of said design solution, wherein the design base module (36) allows architectural typologies to be digitalised and parametrised such that the design of each solution does not need to be encoded, for which purpose the design base module (36) is provided with a drawing with a distribution of a typology which is automatically parameterised; and
a viewing module (37) connected with the assistance module (35) and the design base module (36) and intended for interacting with the user and configured for receiving data from the user and showing data of the assistance module (35) and of the design base module (36) to the user. FIG. 7 shows a particular embodiment of the method implemented by a computer for calculating the optimal space planning and generating the corresponding architectural design of a building making use of a building database (31), comprising a data structure contemplating the different interior distribution possibilities of the spatial units forming the building as well as the different possibilities of associating said units with one another by means of unit distribution possibility tables and compatibility tables of the associations between them, whether horizontal housing, forming floors of a building, vertical housing, setting the compatibility between floors, or both, and wherein the method comprises the steps of:
a) defining (38) design criteria of the units, as well as parameters corresponding to the need program;
b) defining (39), based on a selection of a user, a set of parameters which define the typology and shape of the building;
c) searching for (40) the floors of a building in the building floor table (33) which are as close as possible to the defined floor dimensions in regard to areas and distances, that is, those which deviate the least from the parameters introduced;
d) establishing (41) the different relation possibilities between the selected floors of a building, obtaining vertical groups of floors of buildings each comprising a set of compatible houses;
e) filtering (42) the design solutions that meet the design criteria;
f) selecting (43) the buildings with houses that are as close as possible to the parameters set by the user and that meet the design criteria introduced;
g) calculating (44) the parameters which define the different floors of a building as well as the interior distribution of the houses and which best fit the parameters set by the user by means of multivariable linear regression algorithms applied to the selected building database;
h) generating (45) a graphical representation or drawing of the design solution obtained and extracting a set of measurement parameters;
i) modifying (46) valid design solutions generated by the user by means of drawing editing tools which allows for solutions not contemplated by the automated design system to be covered;
j) calculating (47) the estimate resulting from the construction of the design solutions obtained by means of applying previously stored data on prices of each item on the measurement resulting from each entity generated;
k) calculating (48) the energy efficiency of the resulting building by means of applying an environmental calculation engine; and
l) exporting (49) the valid design solutions generated to a BIM environment.

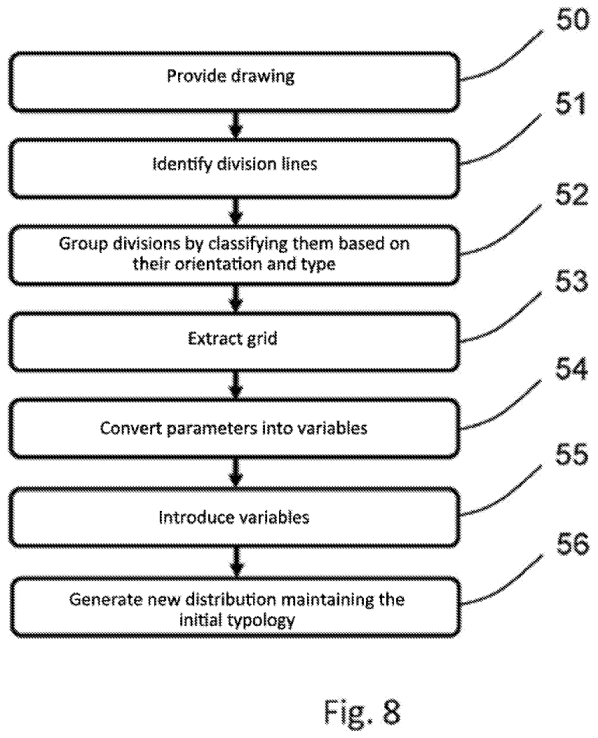

FIG. 8 depicts a particular embodiment of the step of parametrising an architectural typology from a drawing of the distribution thereof, in which the dimensions are variable, comprising the steps of:
providing (50) the drawing to be parametrised with the distribution of the typology (floorplan);
identifying (51) the division lines which demarcate the rooms;
grouping (52) the divisions by classifying them based on their orientation and type;
extracting (53) a grid with axes coinciding with the coordinates or parameters of the groups of lines;
converting (54) these parameters into variables.

Likewise, for generating new floors from this parametric system, it is performed with the following steps:
introducing (55) a value for the system variables; and
generating (56) a new distribution, maintaining the initial topology.

1. A method implemented by a computer for calculating the optimal space planning and generating the corresponding architectural design of a building making use of a building database , comprising a data structure contemplating the different interior distribution possibilities of the spatial units forming the building as well as the different possibilities of associating said units with one another by means of unit or house distribution possibility tables, and compatibility tables of the associations between them, whether horizontal associations, forming floors of a building, vertical associations, setting the compatibility between floors, or both, and wherein the method comprises the steps of:
a) defining design criteria of the units, as well as parameters corresponding to the needs program thereof;
b) defining, based on a selection of a user, a set of parameters which define the typology and shape of the building;
c) searching for the floors of a building in the vertical compatibility table which are as close as possible to the defined floor dimensions in regard to areas and distances, that is, those which deviate the least from the parameters introduced;
d) establishing the different relation possibilities between the selected floors of a building, obtaining vertical groups of floors of buildings each comprising a set of compatible houses;
e) filtering the design solutions that meet the design criteria introduced;
f) selecting the buildings with houses that are as close as possible to the parameters and of the need program of the building set by the user;
g) calculating the parameters which define the different floors of a building as 1. A method implemented by a computer for calculating the optimal space planning and generating the corresponding architectural design of a building making use of a building database, comprising a data structure contemplating the different interior distribution possibilities of the spatial units forming the building as well as the different possibilities of associating said units with one another by means of unit or house distribution possibility tables, and compatibility tables of the associations between them, whether horizontal associations, forming floors of a building, vertical associations, setting the compatibility between floors, or both, and wherein the method comprises the steps of:
a) defining design criteria of the units, as well as parameters corresponding to the needs program thereof;
b) defining, based on a selection of a user, a set of parameters which define the typology and shape of the building;
c) searching for the floors of a building in the vertical compatibility table which are as close as possible to the defined floor dimensions in regard to areas and distances, that is, those which deviate the least from the parameters introduced;
d) establishing the different relation possibilities between the selected floors of a building, obtaining vertical groups of floors of buildings each comprising a set of compatible houses;
e) filtering the design solutions that meet the design criteria introduced;
f) selecting the buildings with houses that are as close as possible to the parameters and of the need program of the building set by the user;
g) calculating the parameters which define the different floors of a building as well as the interior distribution of the houses and which best fist the parameters set by the user by means of regression algorithms, decision trees or neural networks applied to the selected building database.

2. The method of generating design solutions according to claim 1, further comprising a step of generating a graphical representation or drawing of the design solution obtained and extracting a set of measurement parameters.

3. The method implemented by a computer according to claim 2, further comprising a step of parametrising an architectural typology from a drawing of the distribution thereof, maintaining the same original topology or spatial hierarchy of the architectural type introduced, but in which the dimensions are variable, following the steps of:
providing the drawing to be parametrised with the distribution of the typology (floorplan);
identifying the division lines which demarcate the rooms;
grouping the divisions by classifying them based on their orientation and type;
extracting a grid with axes coinciding with the coordinates or parameters of the groups of lines;
converting these parameters into system variables.

4. The method implemented by a computer according to claim 2, further comprising the following steps:
introducing a value for the system variables; and
generating a new distribution, maintaining the initial topology.

5. The method implemented by a computer according to claim 1, further comprising a step of modifying valid design solutions generated by the user by means of drawing editing tools which allows for solutions not contemplated by the automated design system to be covered.

6. The method implemented by a computer according to claim 5, further comprising a step of feeding back into the design base module the variants generated in the step of modifying valid solutions in order to expand the possible solution database with the designs made by users.

7. The method implemented by a computer according to claim 1, comprising an additional step of calculating the estimate resulting from the construction of the design solutions obtained by means of applying previously stored data on prices of each item on the measurement resulting from each entity generated.

8. The method implemented by a computer according to claim 1, further comprising a step of calculating the energy efficiency of the resulting building by means of an environmental calculation engine.

9. The method implemented by a computer according to claim 1, further comprising a step of exporting the valid design solutions generated to a BIM environment.

10. The method implemented by a computer according to claim 8, further comprising the steps of:
applying a calculation algorithm that receives a set of environmental data and data on the surroundings from the administrator of the system and calculates the energy consumption for a design solution,
modifying the position and composition of some previously determined constructive elements without altering the definition of the design generated to minimise energy consumption.

11. The method implemented by a computer according to claim 1, further comprising the steps of:
receiving data on the definition of an empty lot and a set of data of the surroundings provided by the administrator of the system;
obtaining the optimal architectural arrangement for the lot and the data on its surroundings introduced, the optimal architectural arrangement being that which maximises or minimises previously defined optimisation criteria.

12. A system for generating architectural design solutions configured for carrying out the method of claim 1, comprising:
a building database which stores a set of typologies of buildings;
a house table which stores a set of typologies of houses;
a building floor table which stores the horizontal compatibility possibilities of the houses;
a compatible floor table which stores the different vertical compatibility possibilities between the different floors of a building; and
an assistance module configured for receiving a set of parameters of the building, searching for the floors of a building which are as close as possible to the floor dimensions and characteristics defined, that is, the one that deviates the least from the parameters introduced, establishing the possible associations between the selected floors of a building with respect to one another, obtaining vertical groups of floors of buildings each comprising a set of compatible houses, selecting the buildings with houses that are as close as possible to the parameters set by the user, and calculating the dimensions and parameters of the floors of the building and of the houses with the aim of finding the architectural solution which best fits the parameters (areas for each room and dimensions) set by the user by means of the sequenced application of regression algorithms, decision trees or neural networks.

13. The system for generating architectural design solutions according to claim 12, further comprising a design base module, intended for receiving the parameters which completely define the valid design solution of the assistance module and generating a graphical representation of said design solution and extracting a set of measurement parameters of said design solution, wherein the design base module allows architectural typologies to be digitalised and parametrised such that the design of each solution does not need to be encoded, for which purpose the design base module is provided with a drawing with a distribution of a typology which is automatically parameterised.

14. The system for generating architectural design solutions according to claim 12, further comprising a viewing module connected with the assistance module and the design base module and intended for interacting with the user and configured for receiving data from the user and showing data of the assistance module and of the design base module to the user.

15. A computer program adapted to carry out the steps of the method according to claim 1.

16. A machine-readable storage device which comprises the computer program according to claim 15.
